(19) United States
(12) Patent Application Publication
(10) Pub. No.: US 2025/0103942 A1
(43) Pub. Date: Mar. 27, 2025

(54) Systems and Methods for Facilitating Data Interpretation

(71) Applicant: Tybram, LLC, Jacksonville, FL (US)

(72) Inventor: Marriel Harrison, Jacksonville, FL (US)

(21) Appl. No.: 18/372,016

(22) Filed: Sep. 22, 2023

(51) Int. Cl. G06N 20/00

(52) U.S. Cl. CPC G06N 20/00

(57) ABSTRACT

The present disclosure provides generally for systems and methods for facilitating data interpretation. In some aspects, a data interpretation system may comprise at least one data source and at least one artificial intelligence infrastructure. In some implementations, the artificial intelligence infrastructure may be trained to determine one or more predictable outcomes based on data received from the data source, wherein the predictable outcomes may form the basis of at least one data interpretation generated by the data interpretation system. In some embodiments, the data interpretation may be presented to at least one user in the form of a simplified textual or graphical representation that allows the user to understand the representation without requiring specialized knowledge or training.

### BACKGROUND

Training is the process of developing the knowledge and skills of an individual to increase and enable performance of certain tasks and abilities. Since pre-historic times, humans have trained new generations to prepare them for adulthood. In addition, training has always been heavily utilized to ready and improve the workforce for any type of occupation. Depending on the job, there may be a different amount of training required to sufficiently prepare an individual for competency. While education works to train the youth and prepare them to enter the workforce, most jobs still require a training period to ensure new workers are equipped to perform their duties. It is not uncommon for these periods of training to last from a few days to a few months, depending on the role.

Before computers, the vast majority of training was conducted in-person. Businesses had to expend not only resources but valuable time to properly train any newcomers to the organization. With the development of technology, training has become easier and more adaptable. Online training programs and videos have been integrated into the modern workplace to allow new workers to learn on their own and with minimal hands-on practices. Remote onboarding has allowed businesses to provide a detailed training regiment without slowing down their overall productivity. As technology continues to develop, more opportunities for strong and efficient training evolve with it.

Artificial Intelligence (“AI”) is the development of technology that performs tasks that typically require human intelligence. AI has led to machines that are capable of decision making, audio recognition, visual perception, and other human abilities. AI technology is driven by algorithms, step-by-step instructions on how and when the machine should operate and how the machine can learn to operate on its own. Like the human brain, AI learns from the information that it processes, with the understanding of programming developing as it is trained with proper and sufficient data.

AI technology is rapidly expanding in modern day business, helping and strengthening current systems and solutions to create a more efficient and effective workplace. However, AI has yet to be implemented in training scenarios, thereby causing a significant amount of human involvement to remain as instructors, teachers, or mentors are needed to interpret student or trainee performance and provide constructive feedback. This can be particularly costly when it comes to occupations where training is a high barrier to entrance. For example, training for specialized occupations such as pilots, truck drivers, heavy equipment operators, and other specialized vehicles can be incredibly time consuming. If AI technology could adapt and be applied to such training programs, it could create more effective and ready workers while requiring a lower amount of time and money.

### SUMMARY OF THE DISCLOSURE

What is needed are systems and methods for facilitating data interpretation. Systems and methods that facilitate the interpretation of data associated with user training, education, or learning are also desired.

In some aspects, the present disclosure is directed to a data interpretation system. In some implementations, the data interpretation system of the present disclosure may comprise at least one data source and at least one computing device, wherein the computing device may be communicatively coupled to the at least one data source via at least one network connection. In some embodiments, the data interpretation system may further comprise at least one artificial intelligence infrastructure, wherein the artificial intelligence infrastructure may be configured to determine one or more predicted outcomes based on at least one datum received from the at least one data source.

In some implementations, the present disclosure is directed to at least one method for facilitating data interpretation. In some aspects, the method may comprise receiving at least one datum from at least one data source; processing the at least one datum via at least one artificial intelligence infrastructure; and determining at least one predicted outcome via the artificial intelligence infrastructure, wherein the at least one predicted outcome may be at least partially based on the at least one datum.

A number of embodiments of the present disclosure will be described. While this specification contains many specific implementation details, these should not be construed as limitations on the scope of any disclosures or of what may be claimed, but rather as descriptions of features specific to particular embodiments of the present disclosure. It is understood to those skilled in the art that variations, modifications, and alterations may be apparent. It will be understood that various modifications may be made without departing from the spirit and scope of the disclosure.

### BRIEF DESCRIPTION OF THE DRAWINGS

The accompanying drawings that are incorporated in and constitute a part of this specification illustrate several embodiments of the disclosure and, together with the description, serve to explain the principles of the disclosure:

FIG. 1 illustrates an exemplary data interpretation system, according to some embodiments of the present disclosure.

FIG. 2 illustrates exemplary data received from a data source of a data interpretation system, according to some embodiments of the present disclosure.

FIG. 3 illustrates an exemplary data interpretation system, according to some embodiments of the present disclosure.

FIG. 4 illustrates an exemplary data interpretation system, according to some embodiments of the present disclosure.

FIG. 5 illustrates an exemplary data interpretation system, according to some embodiments of the present disclosure.

FIG. 6 illustrates exemplary method steps for a process for facilitating data interpretation, according to some embodiments of the present disclosure.

FIG. 7 illustrates exemplary method steps for a process for generating a training program configured for use with a data interpretation system, according to some embodiments of the present disclosure.

FIG. 8 illustrates exemplary method steps for a process for assessing a user of a data interpretation system, according to some embodiments of the present disclosure.

FIG. 9 illustrates exemplary method steps for a process for providing one or more alterations for a training program configured for use with a data interpretation system, according to some embodiments of the present disclosure.

FIG. 10 illustrates exemplary method steps for a process for facilitating improvement of at least one training program configured for use with a data interpretation system, according to some embodiments of the present disclosure.

FIG. 11 illustrates an exemplary computing system that may be used to implement computing functionality for one or more aspects of a data interpretation system, according to some embodiments of the present disclosure.

### DETAILED DESCRIPTION

The present disclosure provides generally for systems and methods for facilitating data interpretation. According to the present disclosure, a data interpretation system may comprise at least one data source communicatively coupled to at least one computing device. In some aspects, the data interpretation system may further comprise at least one data collector, wherein the data collector may be configured to aggregate or compile data from the data source. In some implementations, data may be transmitted from the data source and/or the data collector to the computing device via at least one transmitting device.

In some aspects, the data interpretation system may comprise one or more coded instructions or algorithms configured to interpret data obtained, either directly or indirectly, from the data source. In some implementations, the coded instructions or algorithms may be at least temporarily stored within at least one storage medium such that the coded instructions or algorithms may be executed by at least one processing device within the computing device, the data collector, or one or more other components of the data interpretation system. In some non-limiting exemplary embodiments, the data interpretation system may comprise at least one artificial intelligence infrastructure configured to perform or execute one or more machine learning or artificial intelligence operations, processes, or calculations on data received from the data source. In some aspects, the artificial intelligence infrastructure may be configured form, generate, determine, or compute one or more predictions or possible outcomes based on data received from the data source, wherein the predictions may be used to generate and present one or more assessed interpretations of the received data.

In the following sections, detailed descriptions of examples and methods of the disclosure will be given. The descriptions of both preferred and alternative examples, though thorough, are exemplary only, and it is understood to those skilled in the art that variations, modifications, and alterations may be apparent. It is therefore to be understood that the examples do not limit the broadness of the aspects of the underlying disclosure as defined by the claims.

### Glossary

Data source: as used herein refers to any electronic or computing device capable of generating, transmitting, storing, or relating at least one datum. By way of example and not limitation, a data source may comprise a flight simulator, a computer-based educational course, or one or more stored test results, one or more stored data sets, as non-limiting examples.
Artificial intelligence infrastructure: as used herein refers to any electronic or computing system configured to execute or perform one or more machine learning or artificial intelligence algorithms, processes, operations, functions, or calculations. By way of example and not limitation, an artificial intelligence infrastructure may comprise a neural network, a deep neural network, or a support-vector machine.
Training program: as used herein refers to any apparatus, machine, data, instructions, algorithm, system, course, content, materials, or similar tool, mechanism, or resource that may be used to train, teach, or otherwise educate at least one user. By way of example and not limitation, a training program may at least partially comprise a simulator, courseware, or both.
Courseware: as used herein refers to any type of educational or training content, materials, or resources, such as, for example and not limitation, one or more lessons, assessments, or activities, that may be delivered, accessed, provided, or otherwise made available in an electronic format or configuration.

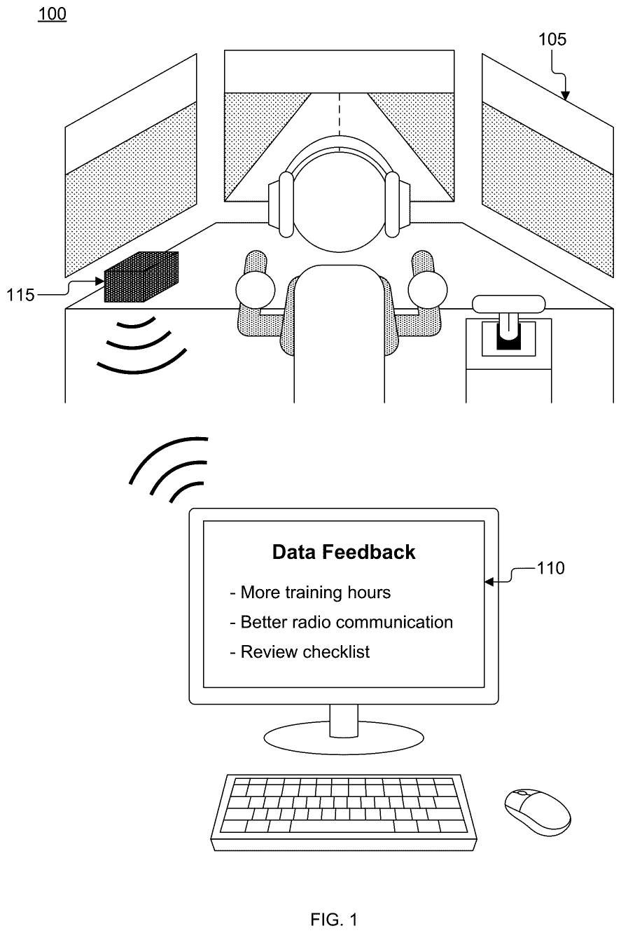

Referring now to FIG. 1, an exemplary data interpretation system 100, according to some embodiments of the present disclosure, is illustrated. In some aspects, the data interpretation system 100 may comprise at least one data source 105 and at least one computing device 110, wherein the data source 105 may be communicatively coupled to the computing device 110 such that the computing device 110 may be able to receive data transmitted or otherwise sent from the data source 105. By way of example and not limitation, the data source 105 may be communicatively coupled to the computing device 110 via at least one network connection, such as a connection to the global, public Internet or a connection to a local area network, or the data source 105 may be communicatively coupled to the computing device 110 via at least one short-range wireless connection or one or more near-field communication protocols, as non-limiting examples.

In some implementations, the data interpretation system 100 may comprise at least one data collector 115. In some aspects, the data collector 115 may comprise an electronic or computing device configured to aggregate or compile data collected, gathered, or otherwise obtained from the data source 105. In some embodiments, compiling the data may help prepare the data for transmission and/or analysis, wherein the transmission or analysis process may be streamlined by facilitating bulk transmission or analysis of data.

In some aspects, the data interpretation system 100 may comprise one or more coded instructions or algorithms configured to execute, perform, or carry out one or more operations, functions, processes, or calculations on data received or obtained from the data source 105. In some non-limiting exemplary implementations, the coded instructions or algorithms may be at least temporarily stored within at least one storage medium such that the coded instructions or algorithms may be accessed and executed by at least one processing device communicatively coupled to the storage medium. In some embodiments, the storage medium and/or the processing device may be configured within one or more of: the computing device 110, the data collector 115, the data source 105, or one or more other components of the data interpretation system 100. In some aspects, the coded instructions or algorithms may be configured as a software application that may be accessible by the computing device 110 via one or more servers or downloaded to at least one storage medium of the computing device 110 from the servers.

In some implementations, the data interpretation system 100 may comprise at least one artificial intelligence infrastructure. In some non-limiting exemplary embodiments, the artificial intelligence infrastructure may be at least partially configured within at least a portion of one or more of: the computing device 110, the data collector 115, the data source 105, or one or more other portions or components of the data interpretation system 100. By way of example and not limitation, the artificial intelligence infrastructure may comprise at least one of: a neural network, a deep neural network, and a support-vector machine, as non-limiting examples.

In some aspects, the artificial intelligence infrastructure of the data interpretation system 100 may be configured to execute, perform, implement, or carry-out one or more machine learning, artificial intelligence, or similar analytical or computational functions, operations, processes, or calculations. In some implementations, the artificial intelligence infrastructure may be configured to receive at least one datum, either directly or indirectly, from the data source 105 and determine one or more predictions or outcomes based on the received data. In some embodiments, the artificial intelligence infrastructure may be configured to use the predictions or outcomes to generate an interpretation of the received data that comprises an assessment, evaluation, or summary of the data, as non-limiting examples.

In some implementations, the artificial intelligence infrastructure may be configured to generate at least one presentable representation of the data interpretation. By way of example and not limitation, the representation may at least partially comprise one or more of: a semantic, graphical, or image-based representation of the data interpretation that may be presented to one or more users via at least one graphical user interface generated and presented by the computing device 110. As a non-limiting illustrative example, the representation of the data interpretation may at least partially comprise one or more words or phrases. In some embodiments, the artificial intelligence infrastructure may be configured to generate a representation comprising one or more words or phrases that may be understood by a layperson with little or no specialized or technical training. In some implementations, this may enable a user of the data interpretation system 100 to receive and understand an interpretation of data received from the data source 105 without being required to possess specialized knowledge or skills pertaining to how to read and understand the raw form of the data.

In some aspects, the artificial intelligence infrastructure may be iteratively trained to generate data interpretations and representations associated therewith with ever-improving efficiency, accuracy, or clarity. In some non-limiting exemplary implementations, the artificial intelligence infrastructure may be trained using one or more of: a supervised machine learning process, an unsupervised machine learning process, or a semi-supervised machine learning process, as non-limiting examples. In some embodiments, the performance of the artificial intelligence infrastructure may progressively improve in correlation to the amount of training data received.

In some implementations, the computing device 110 may be located proximate to

the data source 105, within the general vicinity of the data source 105, or remotely from the data source 105, as non-limiting examples. By way of example and not limitation, the computing device 110 may comprise one or more of: a desktop computing device, a laptop computing device, a tablet computing device, a smartphone, a smart watch, one or more servers, or a gaming console, as non-limiting examples. In some embodiments, the data interpretation system 100 may comprise a plurality of computing devices 110. As a non-limiting illustrative example, the data interpretation system 100 may comprise a first computing device 110 in the form of a desktop computer as well as a second computing device 110 in the form of one or more servers, wherein the servers may comprise at least one artificial intelligence infrastructure configured to analyze and interpret data received from the data source 105 and then transmit the data interpretation to the desktop computer via at least one network connection.

In some aspects, the data interpretation system 100 may be configured to assess or interpret data related to one or more educational, training, or similar learning programs. By way of example and not limitation, the data interpretation system 100 may be configured to receive data obtained from at least one data source 105 that comprises one or more of: a simulator; a computer-based class, course, activity, or exercise; a computer-facilitated test or quiz; or one or more stored test, quiz, or simulator performance results, as non-limiting examples. In some implementations, the data interpretation system 100 may be configured to analyze, interpret, assess, or evaluate data received from the data source 105 and generate one or more representations of the interpreted data that may be presented to a user in a straightforward, simplified, or otherwise easily understood format such that a student, trainee, amateur, novice, or similar user may receive real-time performance or progress feedback without requiring the assistance or input of a specialized instructor, teacher, professor, or mentor. In some aspects, this may help the user progress at a faster rate by receiving feedback that is directed or personalized to the user, or by receiving feedback more often at more frequent intervals due to not having to wait for the availability of a specialized instructor or teacher, as non-limiting examples.

As a non-limiting illustrative example, a data source 105 may comprise a simulator used to train a user to operate a vehicle or machinery. By way of example and not limitation, the data source 105 may comprise a flight simulator used to train pilots, such as for the Air Force or for commercial flight, as non-limiting examples. In some aspects, the flight simulator may record one or more various types of data comprising one or more various flight parameters during the duration of the simulation to monitor a pilot's performance, including but not limited to an identification number for the flight simulation, aircraft altitude, aircraft air speed, aircraft heading, aircraft vertical speed or change in altitude rate, aircraft pitch, aircraft roll, aircraft yaw, experienced G-forces, percentage of afterburner usage during the flight, number of midsole launches during the flight, number of training hours previously undergone by the pilot, pilot navigation accuracy, or pilot decision making time, as non-limiting examples.

In some implementations, the data interpretation system 100 may comprise at least one artificial intelligence infrastructure trained to associate at least one flight outcome with one or more flight parameters. By way of example and not limitation, the artificial intelligence infrastructure may be at least partially trained using a RandomForestClassifier or similar machine learning model to predict the outcome of a flight based on one or more flight parameters received from the data source 105 comprising the flight simulator. In some aspects, once trained, the artificial intelligence infrastructure may comprise the ability to receive new data comprising one or more flight parameters for a current simulation being performed by a user, predict one or more outcomes of the simulated flight based on the received flight parameters, use the predictions to determine one or more assessments or evaluations comprising one or more interpretations of the parameters of the simulated flight, generate at least one representation of the interpretations, and present the representations to the user. In some implementations, the data interpretations and representations may be generated by the artificial intelligence infrastructure and presented to the user in substantially real time upon completing a simulated flight.

In some embodiments, the data interpretation system 100 may comprise a data

source 105 that comprises a simulator, courseware, or any similar apparatus, mechanism, resource, or technology that may be used to train or educate at least one trainee, student, or other user to operate or otherwise utilize one or more vehicles, machines, systems, or system components. By way of example and not limitation, a data source 105 may comprise a simulator or courseware configured to train users to operate one or more of: a submersible vehicle, a watercraft, an aircraft or other aerial vehicle, a spacecraft or satellite, any logistical system or component, or any land-based vehicle, such as a semi-truck, a combat vehicle (such as, for example and not limitation, a tank), a car, a truck, a van, or a motorcycle, as non-limiting examples. In some non-limiting exemplary implementations, the data interpretation system 100 may be utilized to train or educate users in a military or commercial environment or setting.

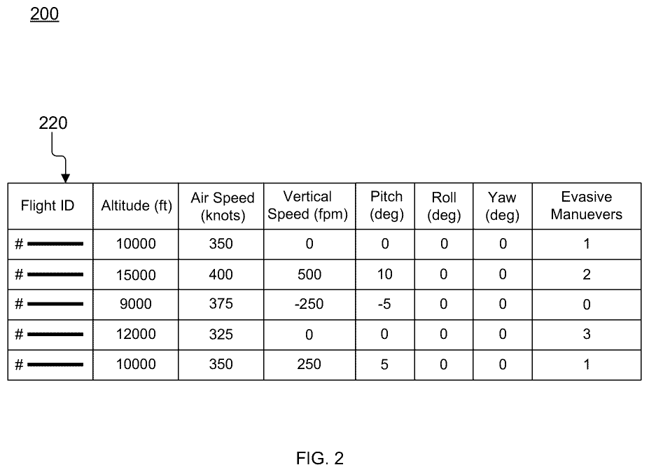

Referring now to FIG. 2, exemplary data 200 received from a data source of a data interpretation system, according to some embodiments of the present disclosure, are illustrated. In some aspects, the data interpretation system may be configured to track, monitor, or record data 200 comprising or related to one or more parameters 220 that may be relevant or useful to generating at least one data interpretation that may be relevant, helpful, or beneficial to a user. As a non-limiting illustrative example, the data interpretation system may be configured to receive data 200 from a data source comprising a flight simulator. In some implementations, the data interpretation system may be configured to track, monitor, or record various flight parameters 220 as a user completes a simulated flight or similar exercise using the simulator. By way of example and not limitation, the flight parameters 220 may comprise one or more of: a flight identification number, an aircraft altitude, an aircraft air speed, an aircraft vertical speed, an aircraft pitch, aircraft roll, aircraft yaw, and a quantity of evasive maneuvers engaged in by the user, as non-limiting examples.

In some implementations, the data interpretation system may be configured to generate at least one interpretation of data received from the data source based at least partially on one or more of the parameters 220. In some aspects, the data interpretation may be at least partially facilitated by at least one artificial intelligence infrastructure. In some embodiments, the artificial intelligence infrastructure may be configured to predict one or more outcomes based on one or more assessments, evaluations, operations, calculations, or similar analytical functions executed or performed on the received data. In some aspects, the predicted outcome(s) may form the basis of one or more interpretations of the data generated or determined by the data interpretation system, wherein the interpretations may be presented to a user of the data interpretation system in the form of one or more semantic, graphical, or image-based representations.

As a non-limiting illustrative example, by monitoring flight parameters 220 such as air speed, altitude, and evasive maneuver count during a flight simulation performed by a user, the artificial intelligence infrastructure of the data interpretation system may be able to predict or determine that the simulated flight would likely have resulted in an unsuccessful aerial mission. This interpretation of the flight parameters 220 may cause the data interpretation system to generate a semantic representation of the interpretation in the form of text stating, for example and not limitation: “Pilot requires more training. Pilot should monitor air speed and altitude during evasive maneuvers to avoid engine stall.” In some aspects, this immediate personalized feedback to the user may expedite the user's training, which may help a user obtain a license or certification in a reduced amount of time.

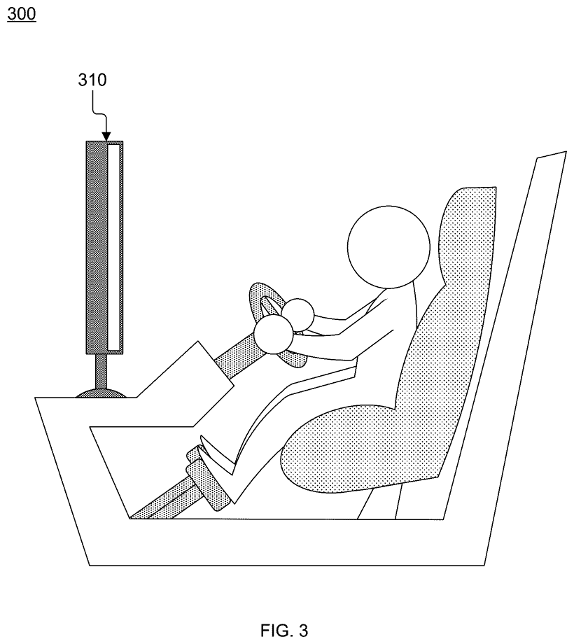

Referring now to FIG. 3, an exemplary data interpretation system 300, according to some embodiments of the present disclosure, is illustrated. In some aspects, the data interpretation system 300 may be utilized in any environment that comprises a simulated user experience to provide real-time instructional or performance-based feedback to the user. In some non-limiting exemplary embodiments, the data interpretation system 300 may be used in a gaming environment, wherein competitive gamers may benefit from learning skills to beat competitive gamers and win large monetary or other prizes or rewards.

In some implementations, the data interpretation system 300 may comprise at least one computing device 310 that comprises at least one display screen, as well as one or more input devices communicatively coupled to the computing device 310, such as a steering wheel, foot pedals, a joystick, a pointing device, or a keyboard, as non-limiting examples. In some aspects, the computing device 310 may comprise at least one artificial intelligence infrastructure, or the computing device 310 may be communicatively coupled to one or more servers that comprise at least one artificial intelligence infrastructure, such that the artificial intelligence infrastructure may be configured to receive data generated as a user engages with the computing device 310 to participate in a gaming experience. In some embodiments, the artificial intelligence infrastructure may be configured to generate one or more interpretations based at least partially on the received data and generate and present one or more representations of the data interpretations to the user in substantially real time upon completing a gaming session.

In some aspects, the artificial intelligence infrastructure of the data interpretation system 300 may be configured to generate at least one data interpretation based at least partially on an assessment of one or more parameters of a user's performance and determine what the user could have done differently to achieve a different outcome. By way of example and not limitation, the user may compete in a virtual gaming experience that simulates an automobile race. In some aspects, the user may lose the race, and the data interpretation system 300 may assess one or more parameters of the user's performance that comprise data pertaining to the speed with which the user approached sharp turns. In some embodiments, the artificial intelligence infrastructure of the data interpretation system 300 may predict that if the user decreased the speed with which a turn is approached, the user would retain greater control of the virtual automobile and thereby decrease the user's overall race time. In some implementations, this interpretation of the data may be presented to the user in a text-based representation generated by the data interpretation system 300 that states “Decrease turn approach speed, then accelerate through the turn.” In some aspects, this personalized insight may enable the user to immediately identify a way to improve without spending days, weeks, or months trying to self-diagnose the problem.

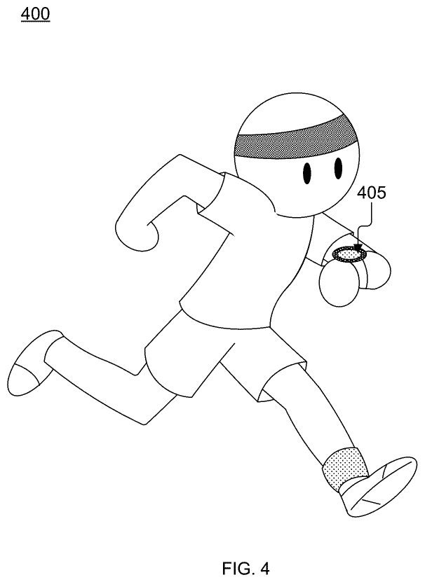

Referring now to FIG. 4, an exemplary data interpretation system 400, according to some embodiments of the present disclosure, is illustrated. In some aspects, the data interpretation system 400 may comprise at least one computing device in the form of one or more remote servers configured to obtain or receive data from a plurality of data sources 405, wherein each data source 405 may comprise at least one wearable technology device. In some non-limiting exemplary embodiments, one or more data sources 405 may comprise one or more fitness devices, trackers, or monitors. By way of example and not limitation, each data source 405 may comprise one or more of: a smart watch or one or more clothing items comprising one or more sensors, such as a headband, an ankle brace, a shirt, or shoe sole inserts, as non-limiting examples. In some implementations, sensors within the clothing items may be configured to sense or detect various biometric or other features of a user during a workout, including heart rate, breathing pattern, pulse, perspiration, body movement, body position, or blood pressure, as non-limiting examples.

In some aspects, by monitoring user biometric data during physical activity, the data interpretation system 400 may be able to provide real-time feedback to the user to help the user improve workout effectiveness or athletic performance. As a non-limiting illustrative example, by monitoring a user's stride pattern and heart rate while running or jogging, an artificial intelligence infrastructure of the data interpretation system 400 may be able to predict that if the user's gait was modified to take longer strides, the user could cover more distance while exerting less effort, thereby increasing the time duration with which the user may maintain a maximum pace. In some implementations, a semantic representation of this data interpretation may be broadcast to the user via audio emitted from a speaker in the user's smart watch that verbalizes the phrase “Taking longer strides may decrease lap time.”

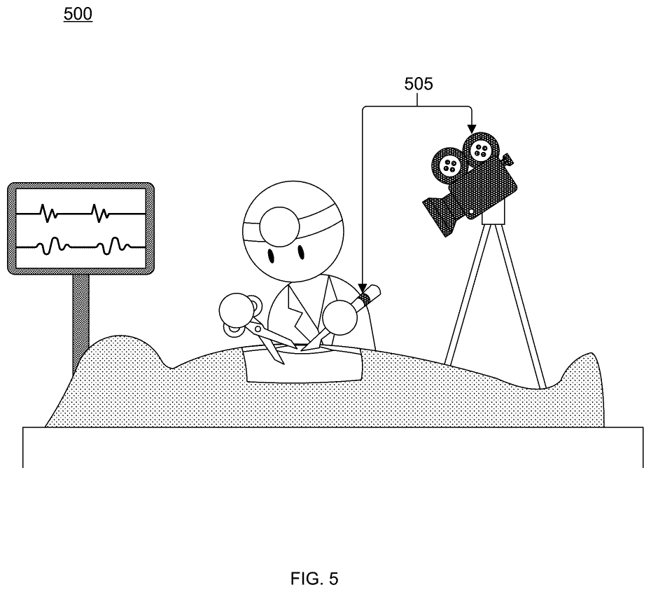

Referring now to FIG. 5, an exemplary data interpretation system 500, according to some embodiments of the present disclosure, is illustrated. In some aspects, the data interpretation system 500 may be utilized in one or more educational training exercises, wherein the data interpretation system 500 may comprise one or more data sources 505 in the form of tools, utensils, or devices embedded or integrated with one or more sensors that may indicate how the devices are being moved, used, positioned, or handled. By way of example and not limitation, sensors in the form of motion detectors and/or accelerometers may indicate when a device is moved or the trajectory of motion in which the device travels, which may facilitate a determination of how the device is used. In some embodiments, a data source 505 may also comprise a camera or similar visual capture device, wherein the data interpretation system 500 may be configured to analyze captured images data to assess or evaluate a user's performance and form or generate one or more interpretations based at least partially on the received image data.

As a non-limiting illustrative example, the data interpretation system 500 may be implemented in a medical training program. In some aspects, the data interpretation system 500 may comprise a plurality of data sources 505 in the form of cameras and medical tools and utensils with integrated sensors. In some implementations, the data interpretation system 500 may comprise at least one artificial intelligence infrastructure configured to receive data from the data sources 505 and predict one or more outcomes that may facilitate the generation of at least one interpretation of the data. By way of example and not limitation, a scalpel embedded with one or more sensors in the form of accelerometers may allow the artificial intelligence infrastructure of the data interpretation system 500 to determine that the user awkwardly fumbles the scalpel based on poor finger technique while practicing a procedure on a cadaver, and so the data interpretation system 500 may be able to provide real-time feedback to the user to improve surgical performance without needing an instructor present to witness the procedure and assess the user.

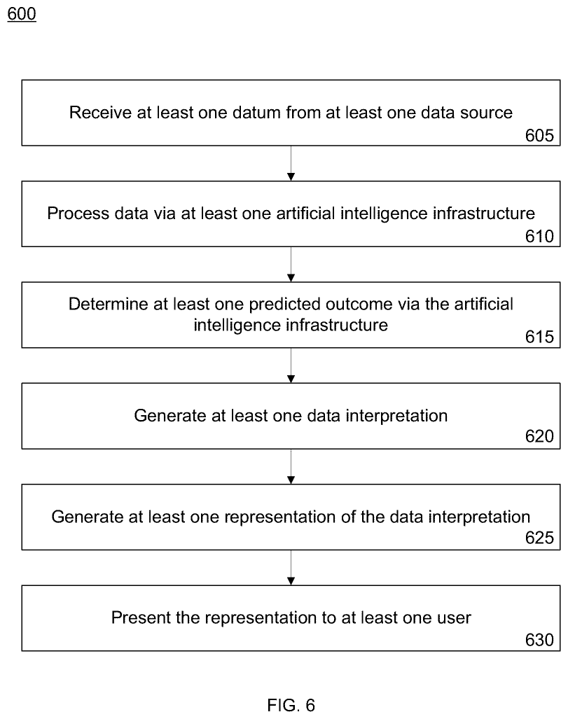

Referring now to FIG. 6, exemplary method steps for a process 600 for facilitating data interpretation, according to some embodiments of the present disclosure, are illustrated. In some aspects, process 600 may be at least partially facilitated by a data interpretation system.

In some aspects, at 605, at least one datum may be directly or indirectly received from at least one data source. In some non-limiting exemplary embodiments, data may be received from the data source via at least one data collector configured to aggregate or compile the data. In some implementations, the data source may be configured to generate, transmit, produce, or relay data that pertains to the performance of at least one user. By way of example and not limitation, the data may pertain to a user's physical performance, mental performance or knowledge, or decision-making skills, as non-limiting examples.

In some embodiments, at 610, the received data may be propagated through or otherwise processed by at least one artificial intelligence infrastructure. In some implementations, the artificial intelligence infrastructure may be trained to execute one or more operations or analytical functions to predict one or more outcomes based at least partially on the received data.

In some aspects, at 615, at least one predicted outcome may be determined by the artificial intelligence infrastructure based at least partially on the received data. In some implementations, the artificial intelligence infrastructure may be trained via at least one machine learning process to associate one or more predictable outcomes with data comprising one or more different parameters. In some embodiments, the artificial intelligence infrastructure may be configured to reference one or more stored metrics in at least one storage medium communicatively coupled to the artificial intelligence infrastructure in determining the predictable outcomes, wherein the stored metrics may influence the weight the artificial intelligence infrastructure gives to each data parameter. As a non-limiting illustrative example, a data source may comprise a flight simulator, and one or more stored metrics comprising the physical specifications (e.g., wingspan, weight, or engine size) of the simulated aircraft may influence the weight with which the artificial intelligence infrastructure processes data parameters in the form of air speed or altitude, as non-limiting examples.

In some implementations, at 620, at least one data interpretation may be generated by the artificial intelligence infrastructure, wherein the data interpretation may be at least partially based on the determined predicted outcomes. By way of example and not limitation, if the predicted outcomes or generally negative, the data interpretation may comprise an assessment of a need for modification or improvement.

In some aspects, at 625, at least one representation of the data interpretation may be generated by the artificial intelligence infrastructure of the data interpretation system. In some non-limiting exemplary implementations, the representation may comprise a semantic or text- based form, or a graphical or image-based form. In some embodiments, the representation may be configured to be presented in “layman's terms” without requiring specialized knowledge to be understood by a user. In some aspects, this may allow the user to understand the interpretation and receive feedback without needing a specialized instructor, teacher, or mentor, which may reduce the amount of time and cost required for the user to receive effective training. In some implementations, at 630, the generated representation may be presented to the user via at least one display screen integrated with or communicatively coupled to at least one computing device.

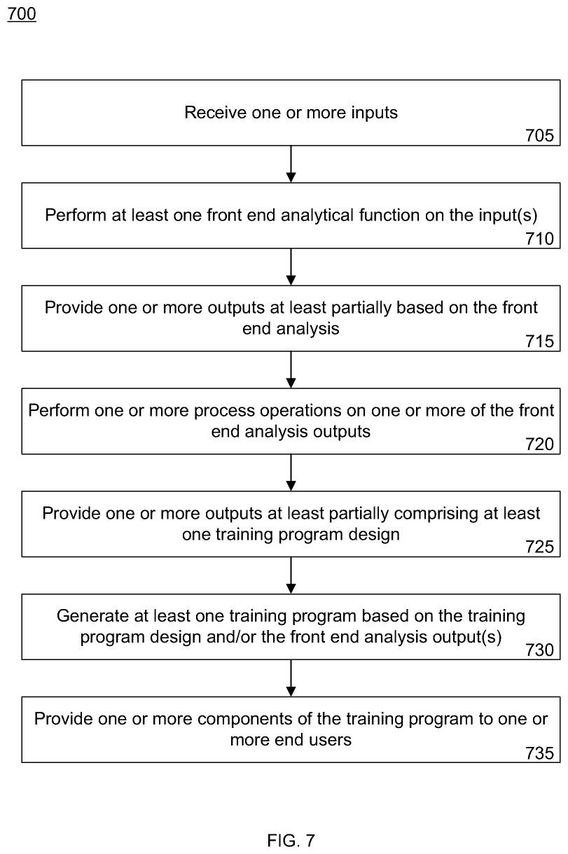

Referring now to FIG. 7, exemplary method steps for a process 700 for generating a training program configured for use with a data interpretation system, according to some embodiments of the present disclosure, are illustrated. In some implementations, process 700 may be at least partially facilitated by a data interpretation system.

In some aspects, at 705, one or more inputs may be received. By way of example and not limitation, the received input(s) may comprise one or more of: a performance work statement, one or more portions of an operating manual (such as, for example and not limitation, an aircraft flight crew operating manual), one or more portions of a quick reference handbook (such as, for example and not limitation, an aircraft quick reference handbook), one or more relevant checklists (such as, for example and not limitation, an aircraft flight and/or mission crew checklist), a pilot electronic flight bag/application, one or more portions of a training manual (such as, for example and not limitation, an aircraft flight crew training manual), one or more portions of a relevant maintenance manual (such as, for example and not limitation, an aircraft maintenance manual), at least one datum from a relevant computing device (such as, for example and not limitation, an aircraft technician/mechanic computing device), one or more relevant maintenance and/or repair task sheets or checklists (such as, for example and not limitation, an aircraft maintenance remove and repair task sheet or checklist comprising one or more pass/fail criteria), or at least one datum from a relevant qualification or certification test (such as, for example and not limitation, an aircraft flight qualification/certification test), as non-limiting examples. In some embodiments, one or more inputs may be received depending on availability of the potential input(s).

In some implementations, at 710, at least one front end analytical function may be executed or performed on the received input(s). In some aspects, at 715, one or more outputs may be provided that may be at least partially based on the performed front end analysis. By way of example and not limitation, the provided output(s) may comprise one or more of: at least one sub-system and one or more derived requirements for the design of at least one training program (such as, for example and not limitation, a simulator or courseware), one or more training program instructor operating station malfunctions that may be used or created for emergency procedures training, at least one identified training program usage datum to be collected during use of a training program to evaluate a user, or at least one identified training program usage datum to be collected during use of a training program to evaluate one or more aspects of the training program itself, as non-limiting examples.

In some aspects, at 720, one or more process operations may be performed on one or more of the front end analysis outputs. In some non-limiting exemplary embodiments, the process operations may at least partially comprise the creation or generation of at least one training program design configured to satisfy, implement, or correspond to one or more of the front end analysis outputs.

In some implementations, at 725, one or more outputs may be provided that may at least partially comprise at least one training program design. By way of example and not limitation, the provided output(s) may comprise one or more of: one or more types of training program material, content, or resources that may be used by a training program teacher or instructor (such as, for example and not limitation, non-simulator courseware material and/or simulator courseware material), simulator hardware technical design data, or simulator software technical data, as non-limiting examples.

In some aspects, at 730, at least one training program may be generated, wherein the training program may be at least partially based on the training program design output(s) provided at 725, one or more of the front end analysis outputs, and/or one or more of the front end analysis inputs. In some implementations, at 735, one or more components of the generated training program may be provided to one or more end users. By way of example and not limitation, the training program component(s) may comprise one or more of: one or more courseware instructional system design software application modules to use for one or more trainees or students, one or more courseware instructional system design evaluation tests configured to evaluate or assess one or more trainees or students, one or more portions or components of simulator hardware integrated with simulator software, one or more simulator qualification test guides, or one or more simulator acceptance test procedures, as non-limiting examples.

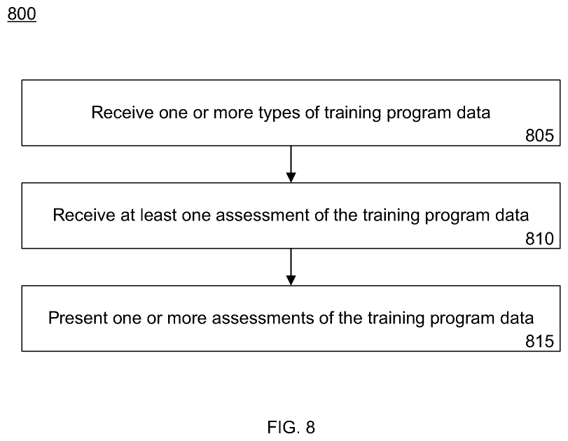

Referring now to FIG. 8, exemplary method steps for a process 800 for assessing a user of a data interpretation system, according to some embodiments of the present disclosure, are illustrated. In some implementations, process 800 may be at least partially facilitated by a data interpretation system. In some embodiments, process 800 may be used to assess at least one user of at least one training program configured for use with a data interpretation system.

In some aspects, at 805, one or more types of training program data may be received. By way of example and not limitation, training program data may at least partially comprise one or more training program records for one or more trainees, students, or other users, such as, for example and not limitation, one or more written test scores, one or more practical test scores, one or more teacher or instructor notes or remarks from one or more simulator sessions, one or more objective result records from at least one simulator check ride session, or one or more simulator oral check ride type rating/−10 operating manual standardization scores, as non-limiting examples.

In some implementations, at 810, at least one assessment of the training program data may be received. By way of example and not limitation, the at least one assessment may be received from at least one instructor, teacher, or mentor of at least one trainee, student, or other user, wherein the assessment may comprise a determination by the instructor as to whether the training program record(s) for the trainee or student satisfy one or more “pass” criteria thresholds or standards, as a non-limiting example.

In some aspects, at 815, one or more assessments of the training program data may be presented. In some embodiments, the assessment(s) may be presented via at least one display screen integrated with or communicatively coupled to at least one computing device. In some implementations, by way of example and not limitation, the assessment(s) may at least partially comprise a determination as to whether at least one trainee or student passed or failed one or more portions of at least one training program.

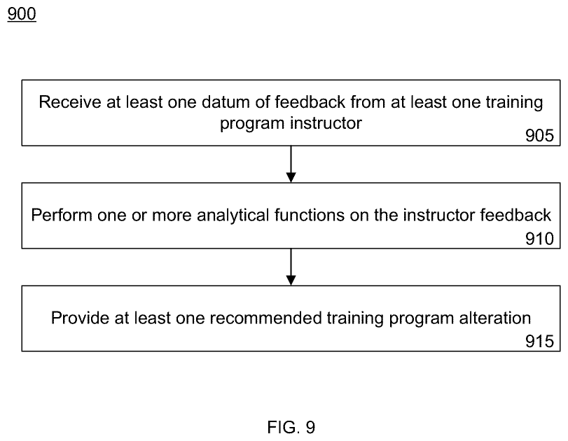

Referring now to FIG. 9, exemplary method steps for a process 900 for providing one or more alterations for a training program configured for use with a data interpretation system, according to some embodiments of the present disclosure, are illustrated. In some implementations, process 900 may be at least partially facilitated by a data interpretation system.

In some aspects, at 905, at least one datum of feedback may be received from at least one training program instructor or teacher. By way of example and not limitation, the feedback may at least partially comprise one or more aspects of the instructor's experience teaching at least one training program, such as one or more types of courseware or one or more simulator sessions, as non-limiting examples.

In some implementations, at 910, one or more analytical functions may be executed or performed on the teacher or instructor feedback. In some non-limiting exemplary embodiments, the analytical function(s) may be configured to identify or determine one or more recommended alterations to at least one training program based at least partially on the received instructor feedback, such as one or more courseware changes or one or more simulator session changes, as non-limiting examples. In some aspects, at 915, at least one recommended training program alteration may be provided or presented, such as, for example and not limitation, via at least one display screen integrated with or communicatively coupled to at least one computing device.

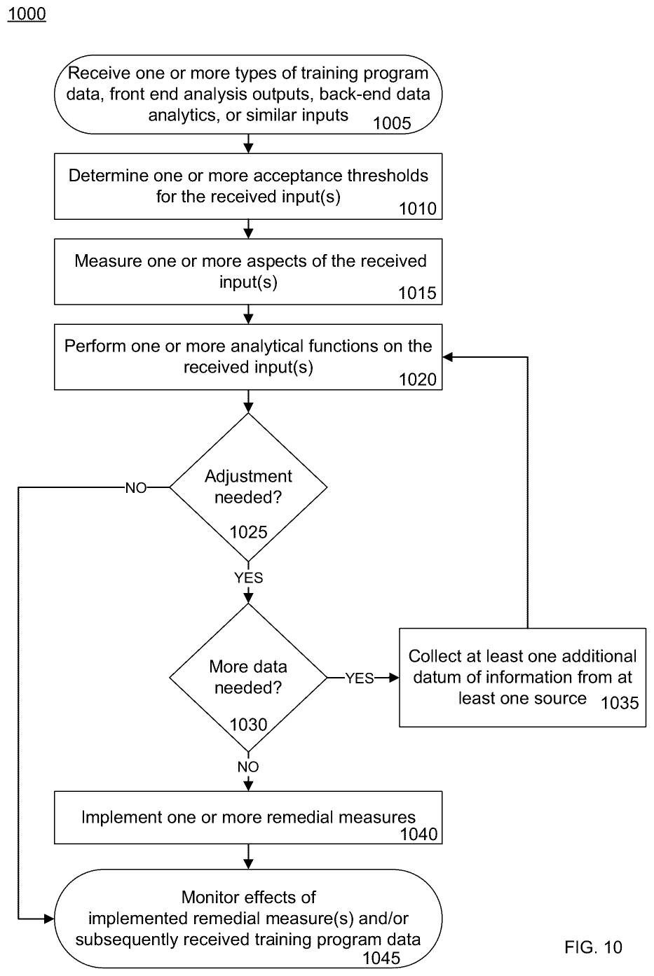

Referring now to FIG. 10, exemplary method steps for a process 1000 for facilitating improvement of at least one training program configured for use with a data interpretation system, according to some embodiments of the present disclosure, are illustrated. In some implementations, process 1000 may be at least partially facilitated by a data interpretation system.

In some aspects, at 1005, one or more inputs may be received. By way of example and not limitation, the received input(s) may comprise one or more of: one or more types of training program data, one or more front end analysis outputs, or one or more back-end data analytics, as non-limiting examples. In some non-limiting exemplary embodiments, training program data may comprise one or more training program records for at least one trainee, student, or other user or one or more types of data or one or more data sets associated with usage of at least one training program, such as collected courseware usage data or collected simulator usage data, as non- limiting examples.

In some implementations, at 1010, one or more acceptable thresholds may be determined for the received input(s). In some aspects, at 1015, one or more aspects of the received input(s) may be measured. In some non-limiting exemplary embodiments, the received input(s) may be measured using one or more back-end data analytics.

In some aspects, at 1020, one or more analytical functions may be executed or performed on the received input(s). In some non-limiting exemplary implementations, the analytical function(s) may be at least partially facilitated by one or more data analysis tools integrated or associated with a data interpretation system, one or more data analysis tools available from at least one third-party, one or more custom data analysis tools, or some combination thereof, as non-limiting examples. By way of example and not limitation, the data analysis tool(s) may be selected or configured to facilitate the generation of one or more of: at least one scatter diagram of one or more data set items associated with or derived from the received input(s), at least one Pareto chart or Pareto analysis of one or more data set items associated with or derived from the received input(s), or any similar data analysis results, summaries, structures, insights, or formats. In some non-limiting exemplary embodiments, two or more data set items may be aggregated prior to one or more analytical functions being performed thereon.

In some implementations, at 1025, at least one determination may be made as to whether any adjustments may be needed or required for the training program(s) associated with the input data received at 1005. In some non-limiting exemplary embodiments, one or more data set items associated with the training program(s) may be identified or selected for improvement based at least partially on the analytical function(s) performed at 1020. In some aspects, one or more of: at least one cause and effect correlation or at least one model of characterization of one or more of the data set items may be generated or received to at least partially facilitate a determination or identification of one or more data set items that may require improvement. In some embodiments, at least one root cause analysis may be performed using one or more data analysis tools to at least partially facilitate a determination or identification of one or more data set items that may require improvement. In some non-limiting exemplary implementations, an identification may be made as to whether any data set item(s) identified or determined to require improvement pertain to a courseware portion or a simulator portion of the relevant training program(s) being analyzed, as non-limiting examples.

In some aspects, if a determination is made that one or more training program adjustments are needed, process 1000 may proceed to 1030. In some embodiments, if a determination is made that no training program adjustments are needed, process 1000 may proceed to 1045.

In some implementations, at 1030, a determination may be made as to whether more data may be needed or required to adequately or sufficiently assess the training program(s) being analyzed. In some non-limiting exemplary embodiments, such determination may be at least partially based on whether any of the data analysis tool(s) performing the analytical function(s) on the received input data failed to generate one or more complete, adequate, or sufficient results. In some implementations, a positive determination may cause process 1000 to proceed to 1035, while a negative determination may cause process 1000 to proceed to 1040.

In some aspects, at 1035, at least one additional datum of training program information may be received from at least one source. In some implementations, at 1040, one or more remedial measures may be implemented. In some embodiments, the implemented remedial measure(s) may be at least partially based on the identified data set(s) identified or determined as needing improvement at 1025.

In some implementations, at 1045, one or more effects of the implemented remedial measure(s) may be monitored and/or any subsequently received training program data input(s) may be monitored. In some embodiments, one or more implemented remedial measures implemented at 1040 may be continuously, routinely, or otherwise regularly tracked or monitored to verify the remedial measures are and remain useful and effective, such as by collecting additional training program data or instructor feedback data, as non-limiting examples.

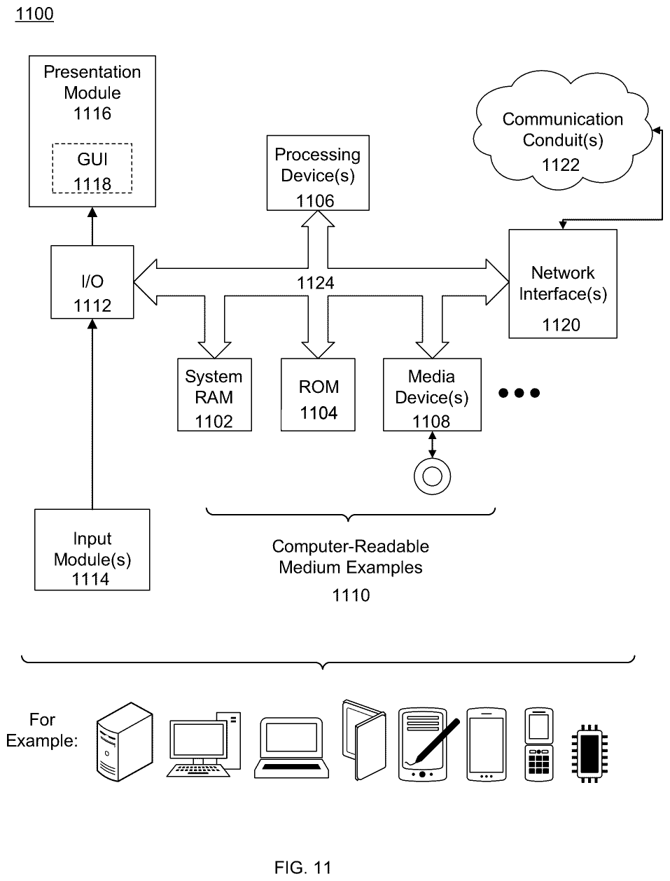

Referring now to FIG. 11, an exemplary computing system that may be used to implement computing functionality 1100 for one or more aspects of a data interpretation system, according to some embodiments of the present disclosure, is illustrated. In some aspects, in all cases computing functionality 1100 may represent one or more physical and tangible processing mechanisms. Computing functionality 1100 may comprise volatile and non-volatile memory, such as RAM 1102 and ROM 1104, as well as one or more processing devices 1106 (e.g., one or more central processing units (CPUs), one or more graphical processing units (GPUs), and the like). Computing functionality 1100 also optionally comprises various media devices 1108, such as a hard disk module, an optical disk module, and so forth. Computing functionality 1100 may perform various operations identified above when the processing device(s) 1106 execute(s) instructions that are maintained by memory (e.g., RAM 1102, ROM 1104, and the like).

More generally, instructions and other information may be stored on any computer readable medium 1110, including, but not limited to, static memory storage devices, magnetic storage devices, and optical storage devices. The term “computer readable medium” also encompasses plural storage devices. In all cases, computer readable medium 1110 represents some form of physical and tangible entity. By way of example and not limitation, computer readable medium 1110 may comprise “computer storage media” and “communications media.”

“Computer storage media” comprises volatile and non-volatile, removable and non-removable media implemented in any method or technology for storage of information, such as computer readable instructions, data structures, program modules, or other data. Computer storage media may be, for example, and not limitation, RAM 1102, ROM 1104, EEPROM, Flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

“Communication media” typically comprise computer readable instructions, data structures, program modules, or other data in a modulated data signal, such as carrier wave or other transport mechanism. Communication media may also comprise any information delivery media. The term “modulated data signal” means a signal that has one or more of its characteristics set or changed in such a manner as to encode information in the signal. By way of example, and not limitation, communication media comprises wired media such as wired network or direct-wired connection, and wireless media such as acoustic, RF, infrared, and other wireless media. Combinations of any of the above are also included within the scope of computer readable medium.

Computing functionality 1100 may also comprise an input/output module 1112 for receiving various inputs (via input modules 1114), and for providing various outputs (via one or more output modules). One particular output module mechanism may be a presentation module 1116 and an associated GUI 1118. Computing functionality 1100 may also include one or more network interfaces 1120 for exchanging data with other devices via one or more communication conduits 1122. In some aspects, one or more communication buses 1124 communicatively couple the above-described components together.

Communication conduit(s) 1122 may be implemented in any manner (e.g., by a local area network, a wide area network (e.g., the Internet), and the like, or any combination thereof). Communication conduit(s) 1122 may include any combination of hardwired links, wireless links, routers, gateway functionality, name servers, and the like, governed by any protocol or combination of protocols.

Alternatively, or in addition, any of the functions described herein may be performed, at least in part, by one or more hardware logic components. For example, without limitation, illustrative types of hardware logic components that may be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), and the like.

The terms “service,” “module,” and “component” as used herein generally represent software, firmware, hardware, or any combination thereof. In the case of a software implementation, the service, module, or component represents program code that performs specified tasks when executed on one or more processors. The program code may be stored in one or more computer readable memory devices. The features of the present disclosure described herein are platform-independent, meaning that the techniques can be implemented on a variety of commercial computing platforms having a variety of processors (e.g., desktop, laptop, notebook, tablet computer, personal digital assistant (PDA), mobile telephone, smart telephone, gaming console, and the like).

### Conclusion

A number of embodiments of the present disclosure have been described. While this specification contains many specific implementation details, these should not be construed as limitations on the scope of any disclosures or of what may be claimed, but rather as descriptions of features specific to particular embodiments of the present disclosure.

Certain features that are described in this specification in the context of separate embodiments can also be implemented in combination or in a single embodiment. Conversely, various features that are described in the context of a single embodiment can also be implemented in combination in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous.

Moreover, the separation of various system components in the embodiments described above should not be understood as requiring such separation in all embodiments, and it should be understood that the described program components and systems can generally be integrated together in a single product or packaged into multiple products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order show, or sequential order, to achieve desirable results. In certain implementations, multitasking and parallel processing may be advantageous. Nevertheless, it will be understood that various modifications may be made without departing from the spirit and scope of the claimed disclosure.

1. A data interpretation system comprising:
at least one data source;
at least one computing device, wherein the at least one computing device is communicatively coupled to the at least one data source, wherein the at least one computing device is configured to compile at least one datum to prepare the at least one datum for transmission and/or analysis based on at least a plurality of a performance work statement, one or more portions of an operating manual, one or more portions of a quick reference handbook, one or more relevant checklists, a pilot electronic flight bag/application, one or more portions of a training manual, one or more portions of a relevant maintenance manual, at least one datum from a relevant computing device, one or more relevant maintenance and/or repair task sheets or checklists with pass/fail criteria, or at least one datum from a relevant qualification or certification test, wherein the transmission or analysis process facilitates bulk transmission or analysis of the at least one datum, wherein the at least one computing device monitors flight parameters including a plurality of an identification number for the flight simulation, aircraft altitude, aircraft air speed, aircraft heading, aircraft vertical speed or change in altitude rate, aircraft pitch, aircraft roll, aircraft yaw, experienced G-forces, percentage of afterburner usage during the flight, number of midsole launches during the flight, number of training hours previously undergone by the pilot, pilot navigation accuracy, or pilot decision making time; and
at least one artificial intelligence infrastructure, wherein the at least one artificial intelligence infrastructure is configured to determine one or more predicted outcomes based on at least one datum received from the at least one data source, wherein the at least one artificial intelligence infrastructure is configured to identify or determine one or more recommended alterations to at least one training program, wherein the at least one artificial intelligence infrastructure is configured to generate at least one presentable representation of a data interpretation at least partially comprising one or more of: a textual, graphical, or image-based representation of the data interpretation presented to one or more users via at least one graphical user interface generated and presented by the computing device, and wherein the data interpretation and the at least one presentable representation is generated by the at least one artificial intelligence infrastructure and presented to the one or more users in real time upon completing a simulated flight.

2. (canceled)

3. (canceled)

4. (canceled)

5. (canceled)

6. The data interpretation system of claim 1, further comprising at least one storage medium comprising one or more stored metrics, including one or more derived requirements for a design of at least one training program one or more training program instructor operating station malfunctions for emergency procedures training, at least one identified training program usage datum to be collected during use of a training program to evaluate a user, or at least one identified training program usage datum to be collected during use of a training program to evaluate one or more aspects of the training program.

7. The data interpretation system of claim 6, wherein the at least one storage medium is communicatively coupled to the at least one artificial intelligence infrastructure, and the at least one artificial intelligence infrastructure is configured to reference the one or more stored metrics while determining the one or more predicted outcomes.

8. (canceled)

9. (canceled)

10. (canceled)

11. (canceled)

12. (canceled)

13. A method for facilitating data interpretation, the method comprising:
receiving input parameters comprising at least a plurality of a performance work statement, one or more portions of an operating manual, one or more portions of a quick reference handbook, one or more relevant checklists, a pilot electronic flight bag/application, one or more portions of a training manual, one or more portions of a relevant maintenance manual, at least one datum from a relevant computing device, one or more relevant maintenance and/or repair task sheets or checklists with pass/fail criteria, or at least one datum from a relevant qualification or certification test;
receiving at least one datum from at least one data source:
monitoring flight parameters including at least three of an identification number for the flight simulation, aircraft altitude, aircraft air speed, aircraft heading, aircraft vertical speed or change in altitude rate, aircraft pitch, aircraft roll, aircraft yaw, experienced G-forces, percentage of afterburner usage during the flight, number of midsole launches during the flight, number of training hours previously undergone by the pilot, pilot navigation accuracy, or pilot decision making time;
processing the at least one datum via at least one artificial intelligence infrastructure;
compiling at least one datum to prepare the at least one datum for transmission and/or analysis, wherein the transmission or analysis process facilitates bulk transmission or analysis of the at least one datum; and
determining at least one predicted simulated flight outcome via the at least one artificial intelligence infrastructure based on whether the simulated flight outcome comprises a success or failure of a simulated aerial mission based on the monitoring, wherein the at least one predicted simulated flight outcome is at least partially based on the at least one datum, wherein the at least one artificial intelligence infrastructure is configured to identify or determine one or more recommended alterations to at least one training program, wherein the at least one artificial intelligence infrastructure is configured to generate at least one presentable representation of a data interpretation at least partially comprising one or more of:
a textual, graphical, or image-based representation of the data interpretation presented to one or more users via at least one graphical user interface generated and presented by the computing device, and wherein the data interpretation and the at least one presentable representation is generated by the at least one artificial intelligence infrastructure and presented to the one or more users in real time upon completing a simulated flight, and wherein the at least one artificial intelligence infrastructure is configured to determine.

14. (canceled)

15. (Canceled)

16. (canceled)

17. (canceled)

18. (canceled)

19. The method of claim 13, further comprising receiving one or more derived requirements for a design of at least one training program, one or more training program instructor operating station malfunctions for emergency procedures training, at least one identified training program usage datum to be collected during use of a training program to evaluate a user, or at least one identified training program usage datum to be collected during use of a training program to evaluate one or more aspects of the training program.

20. (canceled)
